(19) United States
(12) Patent Application Publication
(10) Pub. No.: US 2010/0295396 A1
(43) Pub. Date: Nov. 25, 2010

(54) Separating can and method for producing the same

(76) Inventors: Ralf Bode, Moers (DE); Sebastian Lang, Krefeld (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/678,843

(22) PCT Filed: Sep. 19, 2008
(86) PCT No.: PCT/EP2008/062526

§ 371 Date: Mar. 18, 2010

(30) Foreign Application Priority Data
Sep. 21, 2007 (EP) 07018541.8

(51) Int. Cl. H02K 5/128

(52) U.S. Cl. 310/86

(57) ABSTRACT

A separating can is provided. Fluid flow engines and drive motors can be encased in a housing, if a separation is made in the electric motor by a tube-shaped component, known as the separating can. The separating can must be sufficiently large to be strong and electrically non-conductive. The separating can is made at least partially of a ceramic or glass-like material, or is made at least partially of a polymer matrix reinforced using fibers.

### CROSS REFERENCE TO RELATED APPLICATIONS

This application is the U.S. National Stage of International Application No. PCT/EP2008/062526, filed Sep. 19, 2008 and claims the benefit thereof. The International Application claims the benefits of European Patent Office application. No. 07018541.8 EP filed Sep. 21, 2007. All of the applications are incorporated by reference herein in their entirety.

### FIELD OF INVENTION

The invention relates to a separating can and a method for producing the same.

### BACKGROUND OF INVENTION

Turbomachines and their electrical drive motors are usually housed in separate casings. As a result, shaft seals intended to prevent the fluid that is handled from leaking to the outside are required in the turbomachines.

The turbomachine and the drive motor can be housed in a casing without a shaft seal if a separation between the rotor, which comes into contact with the fluid, and the stator takes place in the electric motor by means of a tubular component. Because of its position in the air gap, the component is referred to as a “separating can”.

Previously used separating cans have one or more of the following disadvantages:

a) Electrical conductivity: the separating can heats up due to eddy currents. The heat must be removed and the overall performance of the machine is very limited.

b) Low strength: the separating is only able to withstand small differences between internal pressure and external pressure. The technique is not suitable for high-pressure machines.

c) The production technology only allows a small overall height of the separating can, as a result of which the overall size of the machine is restricted.

It has previously only been possible for small machines (particularly pumps) of relatively low output to be constructed with a separating can or split case. The following materials have previously been used for this:

a) Metallic special or superalloys, such as Hastelloy or Inconel

(Disadvantage: the electrical conductivity induces eddy currents, which would unacceptably reduce the efficiency of high-performance compressors)

b) CRP, carbon fiber reinforced plastics

(Disadvantage: the carbon fiber also still has an excessively high electrical conductivity, which would greatly reduce the efficiency of high-performance compressors—on account of the induced eddy currents)

c) Particle or glass fiber reinforced and unreinforced high-performance polymers (e.g. FORTRON from the Ticona company)

(Disadvantage: the achievable stiffness and strength are much too low for use in high-pressure compressors)

d) Monolithic technical ceramic such as zirconium dioxide (e.g. FRIALIT from the Friatec company)

(Disadvantage: previously when producing split cases, ceramic powder was first pressed cold-isostatically (green compact) and subsequently sintered. The sintering process thereby causes a shrinkage of 18-25% and strength-reducing structural defects. Moreover, when sintering very large split cases—as are required for high-pressure compressors - mass-related deformations would occur, even the formation of cracks. For these reasons, it has not previously been possible to produce separating cans or split cases with a length significantly above 300 mm from one piece. Moreover, the damage tolerance achievable by means of this production method under pressures of up to 150 bar is too low).

DE 20 2004 013 081 U1 discloses a separating can which consists of a ceramic or glass-like material. DE 200 07 099 U1 and US 2003/193260 A1 describe sintered ceramic separating cans. Such separating cans are too brittle for the intended use. A separating can described in US 6,293,772 B1 consists of a fiber reinforced polymer matrix, which may in particular have polymer fibers and be reinforced by means of ceramic.

In the same way, DE 38 23 113 C1 and U.S. Pat. No. 4,952,429 A disclose protection from abrasion, particularly superficial protection, by means of ceramic particles, for example zirconium oxide. Split cases with partly ceramic contents are also described in DE 39 41 444 A1, DE 197 44 289 A1 and DE 34 13 930 A1. All of the solutions presented do not sufficiently satisfy the set of requirements described above, in particular with regard to the elasticity and strength requirements.

### SUMMARY OF INVENTION

It is therefore an object of the invention to provide a separating can which is able to withstand high pressure differences and a method for producing the same.

To achieve the object, it is proposed according to the invention that the separating can has the features of claim 1. The back-referenced claims comprise advantageous developments.

The separating can may also be produced by correspondingly suitable ceramic fibers being wound in suitable orientation onto a mandrel while a binder is added, it being possible for the binder to consist of a ceramic or glass-like powder or a slip of a ceramic/glass-like powder, and the binder sinters or fuses together as a result of subsequent heat treatment, which may take place in the atmosphere or in air or in an HIP installation.

In this case, the process may either be conducted in such a way that the wound fiber body is initially only provided with a basic mechanical strength, and may still undergo mechanical processing, or that the separating can is provided right away with the required strength and sealing integrity for the application.

As an alternative to this, the sealing integrity may be achieved by the pores of the heat-treated fiber body being closed after the process described above. This may take place, for example, by high-pressure infiltration with liquid glass or by an enameling process involving immersion in a liquid slip (frit) and subsequent firing or glazing of the surface or by other suitable processes.

Disadvantages of previous separating can constructions can be avoided if a separating can of a ceramic fiber reinforced polymer matrix is used. Silicon carbide fibers or high-purity aluminum oxide fibers or zirconium dioxide fibers or else mullitic fibers may be used, inter alia, for this. All these fibers provide high tensile load-bearing capacity. The load-bearing capacity can be further increased if the type of interlinkage of the fibers is optimized, in particular if short fibers or random fibers or continuous filaments or bundles of fibers (rovings) and fiber mats (woven or laid structures, etc.) are used. The abrasion resistance of the polymer matrix can be advantageously increased if the surface of the separating can is also additionally interspersed or coated with ceramic particles.

### BRIEF DESCRIPTION OF THE DRAWINGS

The invention is explained in more detail below on the basis of a specific exemplary embodiment with reference to drawings, in which:

FIG. 1 is a schematic representation of a longitudinal section through a compressor unit with a separating can according to the invention.

### DETAILED DESCRIPTION OF INVENTION

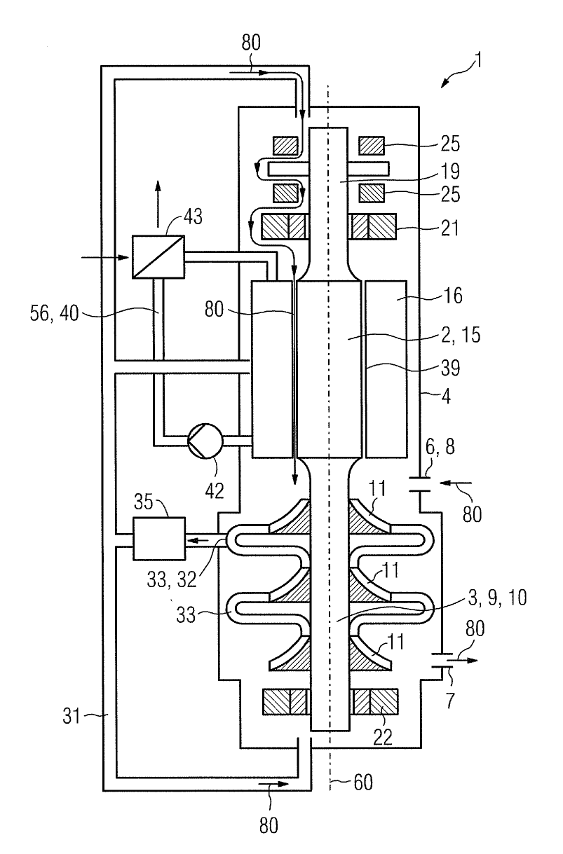

FIG. 1 schematically shows a section along a compressor unit 1, which has as essential components a motor 2 and a compressor 3 in a casing 4 of a gastight form. The casing 4 houses the motor 2 and the compressor 3. In the region of the transition from the motor 2 to the compressor 3, the casing 4 is provided with an inlet 6 and an outlet 7, with fluid that is to be compressed being sucked in through the inlet 6 by means of an intake stub 8 and the compressed fluid flowing out through the outlet 7.

The compressor unit 1 is arranged vertically during operation, a motor rotor 15 of the motor 2 being combined with a compressor rotor 9 of the compressor 3 to form a common shaft 19, which rotates about a common vertical axis of rotation 60.

The motor rotor 15 is mounted in a first radial bearing 21 at the upper end of the motor rotor 15.

The compressor rotor 9 is mounted by means of a second radial bearing 22 in a lower position.

At the upper end of the common shaft 19—that is to say at the upper end of the motor rotor 15—an axial bearing 25 is provided.

The compressor 3, formed as a centrifugal compressor, has three compressor stages 11, which are respectively in connection with an overflow 33.

The electromagnetic bearings 21, 22, 25 are cooled to operating temperature by means of a cooling system 31, the cooling system 31 providing a tap 32 in an overflow of the compressor 3. From the tap 32, part of the medium being handled, which is preferably natural gas, is directed through a filter 35 and subsequently passed through two separate pipelines to the respectively outer bearing locations (first radial bearing 21 and fourth radial bearing 24 as well as axial bearing 25). This cooling by means of the cold medium being handled 80 dispenses with the need for additional supply lines.

The motor rotor 15 is surrounded by a stator 16, which has an encapsulation formed on the inner diameter as a separating can 39, so that the aggressive medium being handled 80 does not damage windings of the stator 16. The separating can 39 is designed here in such a way that it is able to withstand the full operating pressure. This is also because the stator is provided with separate cooling 40, in which a dedicated cooling medium 56 circulates. A pump 42 provides a circulation here via a heat exchanger 43. At least the separating can 39 is configured in such a way that the portion that extends between the stator 16 and motor rotor 15 has a thin wall thickness but is nevertheless capable of withstanding the design pressure when the stator cooling 40 is completely filled with the cooling medium 56. In this way, relatively great eddy current losses in this region are avoided and the efficiency of the overall arrangement is improved.

1-10. (canceled)

11. A separating can, comprising:
a polymer matrix which is reinforced using a plurality of fibers, wherein polymer matrix is at least partly a ceramic fiber reinforced polymer matrix.

12. The separating can as claimed in claim 11, wherein the plurality of fibers comprise silicon carbide.

13. The separating can as claimed in claim 12, wherein the plurality of fibers comprise aluminum oxide.

14. The separating can as claimed in claim 12, wherein the plurality of fibers comprise zirconium dioxide.

15. The separating can as claimed in claim 12, wherein the plurality of fibers are formed as short fibers.

16. The separating can as claimed in claim 15, wherein the plurality of short fibers include a length between 0.1 mm and 1 mm.

17. The separating can as claimed in claim 13, wherein the plurality of fibers are formed as short fibers.

18. The separating can as claimed in claim 14, wherein the plurality of fibers are formed as short fibers.

19. The separating can as claimed in claim 11, wherein the plurality of fibers form a random interlinkage with one another.

20. The separating can as claimed in claim 16, wherein the plurality of fibers form the random interlinkage with one another.

21. The separating can as claimed in claim 17, wherein the plurality of fibers form the random interlinkage with one another.

22. The separating can as claimed in claim 18, wherein the plurality of fibers form the random interlinkage with one another.

23. The separating can as claimed in claim 11, wherein the plurality of fibers are formed as continuous filaments.

24. The separating can as claimed in claim 23, wherein the continuous filaments include the length of at least 30 mm.

25. The separating can as claimed in claim 11, wherein the fibers are formed as a bundle of fibers.

26. The separating can as claimed in claim 11, wherein the plurality of fibers are formed as a fiber mat.

27. The separating can as claimed in claim 13, wherein the plurality of fibers are formed as the fiber mat.

28. The separating can as claimed in claim 14, wherein the plurality of fibers are formed as the fiber mat.

29. The separating can as claimed in claim 11, wherein a surface of the separating can is interspersed with a plurality of ceramic particles.

30. The separating can as claimed in claim 13, wherein the surface of the separating can is interspersed with a plurality of ceramic particles.
